(19) United States
(12) Patent Application Publication
(10) Pub. No.: US 2017/0026694 A1
(43) Pub. Date: Jan. 26, 2017

(54) ADAPTIVE SELECTION AMONGST ALTERNATIVE FRAMEBUFFERING ALGORITHMS IN EFFICIENT EVENT-BASED SYNCHRONIZATION OF MEDIA TRANSFER FOR REAL-TIME DISPLAY RENDERING

(71) Applicant: GM Global Technology Operations LLC, Detroit, MI (US)

(72) Inventors: Fan Bai, Ann Arbor, MI (US); Dan Shan, Troy, MI (US); Leonard C. Nieman, Warren, MI (US); Donald K. Grimm, Utica, MI (US); Karen Juzswik, Ypsilanti, MI (US)

(21) Appl. No.: 15/065,159

(22) Filed: Mar. 9, 2016

Related U.S. Application Data
(63) Continuation-in-part of application No. 14/808,166, filed on Jul. 24, 2015.

(51) Int. Cl. H04N 21/44; H04N 21/45; H04N 21/4363; H04N 21/845; H04N 21/414; H04N 21/41

(52) U.S. Cl. CPC H04N 21/44004; H04N 21/41422; H04N 21/4126; H04N 21/43635; H04N 21/43637; H04N 21/8456; H04N 21/4516

(57) ABSTRACT

An apparatus for use in rendering media in real-time by way of a distributed arrangement comprising a portable system and a host device. The apparatus includes a processing hardware unit and a non-transitory storage device comprising code causing the processing hardware unit to select a multi-tier frame-buffering technique, of a plurality of optional multi-tier frame-buffering techniques, to use for processing media data at the portable system and transferring the media data, as processed, from the portable system to the host device. The code also causes the processing hardware unit to initiate transferring, according to the selected frame-buffering technique, the processed media data by the portable system to the host device for processing at the host device for rendering the media. The apparatus in various embodiments includes the portable system and/or the host device. The plurality of optional multi-tier frame-buffering techniques include a circular frame-buffering technique and a single-file frame-buffering technique.

### TECHNICAL FIELD

The present disclosure relates generally to systems and methods for efficient event-based synchronization of media transfer between distributed devices for real-time display rendering and, more particularly, to systems and methods enabling adaptive selection amongst alternative framebuffering algorithms in the connection with the synchronization operations.

### BACKGROUND

Most modern automobiles are equipped by original equipment manufacturers (OEMs) with infotainment units that can present media including visual media. The units can present audio received over the Internet by way of an audio application running at the unit, for instance, and present video received from a digital video disc (DVD), for instance. While many units can also present visual media such as navigation and weather information received from a remote source, presenting video received from a remote source remains a challenge.

Other display devices or components, such as televisions and computer monitors, can receive video data by way of a high-throughput, or high-transfer-rate interface such as a High-Definition Multimedia Interface (HDMI) or Video Graphics Array (VGA) port. (HDMI is a registered trademark of HDMI Licensing, LLC, of Sunnyvale, Calif.) Digital media routers have been developed for plugging into these high-transfer-rate ports for providing video data to the display device.

Most host devices, such as legacy automobiles already on the road, do not have these high-transfer-rate interfaces. Increasingly, modern vehicles have a peripheral port, such as a universal-serial-bus (USB) port, or a wireless receiver for use in transferring only receiving relatively low-transfer-rate data from a mobile user device such as a smart phone.

Transferring video data efficiently and effectively by way of a lower-transfer-rate connection, such as USB remains a challenge. Streaming video data conventionally requires high data rates. While HDMI data rates can exceed 10 Gbps, USB data rates do not typically exceed about 4 Gbps.

Barriers to transferring video data efficiently and effectively from a remote source to a local device for display also include limitations at the local device, such as limitations of legacy software and/or hardware at the local device. Often, the mobile user devices do not have a video card and/or the vehicles do not have graphics-processing hardware. And, for example, USB video class (UVC) is not supported by either commercial Android ® devices or prevailing infotainment systems. (ANDROID is a registered trademark of Google, Inc., of Mountain View, Calif.)

Another barrier to transferring video data from a remote source to a local display is a high cost of hardware and software required to time-synchronize transmissions between devices to avoid read-write conflict.

### SUMMARY

There is a need for a peripheral system or a host device configured to adaptively select amongst various framebuffering algorithms to use in efficient event-based synchronization of media transfer, from the peripheral system to the host device, for real-time display rendering.

The algorithms can be used in operations to transfer high-speed video streams in an efficient and synchronized manner between the connected peripheral system and the host device with low latency, and without expensive time-synchronization components. Example high-speed video streams include video for streaming at a receiving device. Example connections between the peripheral system and the host device include of a relatively low-rate connection such as a USB connection.

The present technology solves prior challenges related to transferring high-throughput media from a source, such as a remote application server, to a destination host device, such as an automobile head unit.

The present technology processes data having a file format, and the result is a novel manner of streaming video and audio. The data being processed at any time includes a volume of still images. The still-image arrangement involving the volume, e.g., thousands, of still images, facilitates delivery of high-speed streaming video, with low latency. The process includes flushing a cache. The implementation includes use of a plug-in mass-storage system, such as one using a USB mass storage class (USB MSC) protocol.

The disclosure presents systems for synchronizing transfer and real-time display of high-throughput media, such as streaming video, between a peripheral, or portable system, such as a USB plug-in mass-storage system, and a destination host device. The media is synchronized in a novel, event-based manner that obviates the need for expensive clock-based synchronization components.

In one aspect, the present disclosure relates to a portable system comprising a processing hardware unit and a non-transitory storage device comprising computer-executable code that, when executed by the processing hardware unit, causes the processing hardware unit to perform various operations of the current technology. The portable system can be referred to by terms such as peripheral, travel system, mobile system, travel or mobile companion, portable device, or the like, by way of example.

The portable system is configured to receive a source streaming video—e.g., video file—from a video source, such as a remote video source (e.g., server), and dividing the source streaming video into a plurality of equal- or non-equal-sized image components. A resulting data-content package is stored at the system such as at a framebuffer thereof. The framebuffer can be, for instance, a transferred video source, such as in the form of a data content package.

The portable system is further configured to generate a meta-index package comprising a plurality of index components, each index component corresponding to a respective one of the equal- or non-equal-sized image components. The portable system is also configured to store the meta-index package to the non-transitory storage device. The operations further comprise sending the data-content package and the meta-index package to the host device for publishing of the image components sequentially, in accord with an order of the meta-index package, for display rendering streaming video, corresponding to the source streaming video, by way of the host device and a display device. This arrangement, involving transfer and real-time display of the data-content package and the meta-index package corresponding thereto can be referred to as, for instance, a two-tier, dual-tier, bi-tier, multi-tier, or multi-tiered arrangement.

Further regarding embodiments in which the portable system and the host device are configured for bidirectional, or duplex, communications between them, instructions or data can be sent between the two by way of a first, forward channel, from the portable system to the host device, and by way of a second, back channel, from the host device, back to the portable system.

Instructions or data can be configured to change a setting or function of the receiving host device or portable system, for instance. In some implementations, the portable system, host device, and communication channel connecting them are configured to allow simultaneous bidirectional communications.

In some embodiments, the portable system includes a human-machine interface (HMI), such as a button or microphone. The portable system is configured to receive user input by way of the HMI, and trigger any of a variety of actions, including establishing a user preference at the peripheral system, altering a preference established previously at the peripheral system, and generating an instruction for sending from the portable system to the host device.

In various embodiments, the portable system and the host device comprise a computer-executable code in the form of a dynamic programming language to facilitate interactions between the portable system and the host device.

The portable system in some embodiments uses a first-level cache to store the image components formed. The mentioned framebuffer can be a part of the first-level cache, for instance.

In various embodiments, the host system is configured for implementation as a part of a vehicle of transportation, such as an automobile comprising a communication port and a display screen device mentioned. The portable system can in this case include a communication mass-storage-device-class computing protocol (e.g., USB MSC protocol) for use in communications between the portable system and a processing hardware unit of the host device.

The host device is configured to receive user input by way of any of a variety of HMI, such as the mentioned screen being touch sensitive.

User input to the host device can trigger any of many actions, including establishing a user preference at the host device, altering a preference previously established at the host device, and generating an instruction for sending to the peripheral system.

Instruction from the host device to the portable system can be configured to affect portable system operations, such as a manner by which the portable system divides a source video to form indexed image components.

In aspects, the technology includes an apparatus, for use in rendering media in real-time by way of a distributed arrangement comprising a portable system and a host device. The apparatus includes a processing hardware unit and a non-transitory storage device having computer-executable code that, when executed by the processing hardware unit, causes the processing hardware unit to perform various operations.

The operations include selecting a multi-tier frame-buffering technique, of a plurality of optional multi-tier frame-buffering techniques, to use for processing media data at the portable system and transferring the media data, as processed, from the portable system to the host device; and

The operations also include initiating transferring, according to the selected frame-buffering technique, the processed media data by the portable system to the host device for processing at the host device for rendering the media.

In embodiments, the plurality of optional multi-tier frame-buffering techniques consists of a circular frame-buffering technique and a single-file frame-buffering technique.

According to the circular frame-buffering technique, the portable system, (a) forms a group of media snippets based on source media, for a content tier, (b) associates a group of index files, for an index tier, to the group of media snippets, each index file being associated with a corresponding one of the media snippets, and (c) sends a multi-tier packet, comprising the group of media snippets and the group of corresponding index files, to the host device; and

According to the single-file frame-buffering technique, the portable system (i) separates source media into media snippets, for a content tier, (ii) associates each of a plurality of index files, for an index tier, with a corresponding one of the media snippets, yielding index file/media snippet pairs, and (iii) sends each index file/media snippet pair to the host device separately.

Selecting the multi-tier frame-buffering technique is performed, in various embodiments, based on at least one variable selected from a group consisting of:
an identity of an application to be used in rendering the media at the host device;
a type of application to be used in rendering the media at the host device;
an application category to which belongs the application to be used in rendering the media at the host device;
a characteristic of the media being transferred;
an identity of the media being transferred; and
a characteristic of a vehicle status, such as a characteristics or status indicated by one or more of various vehicle sensor readings.

The source media can include a source video file, a virtualized source video, or an equivalent consecutive-image-flow data set representing the screen framebuffer display of any application running at the portable system—or, any other consecutive-image-flow data set source.

In some of the disclosed embodiments, the apparatus includes the portable system and/or the host device.

Initiating transfer of the source media comprises initiating transfer of the media snippets being equal-sized media components generated at the portable system based on the source media. The media components can be, for instance, image files formed by dividing a source video file.

In another aspect, the technology includes a host device for use in rendering media in real-time by way of a distributed arrangement comprising a portable system, the host device or both. The host device includes a processing hardware unit and a non-transitory storage device comprising computer-executable code configured to cause the unit to perform various operations.

The operations include receiving, from the portable system, source media configured according to one of a plurality of optional multi-tier frame-buffering techniques, the media files comprising content files or components, of a content tier, and index files, of an index tier, each index file corresponding to a respective one of the content components or components.

The operations include publishing, to a display component in communication with the processing hardware unit, content of the content components or components sequentially, in accord with an order of the index components, for display rendering the source media.

In various embodiments, receiving the source media comprises receiving the content components, being equal-sized, or non-equal-sized, image components or video generated at the portable system based on the source media, and receiving the index files, each index file corresponding to a respective one of the equal- or non-equal sized image components, or video.

In various embodiments, the plurality of optional multi-tier frame-buffering techniques consists of a circular frame-buffering technique and a single-file frame-buffering technique.

In still another aspect, the technology includes a portable system for use in rendering media in real-time by way of a distributed arrangement comprising the portable system and a host device. The portable system includes a processing hardware unit, and a non-transitory storage device comprising computer-executable code configured to cause the unit to perform various operations. The operations include, for example, receiving source media from a media source, dividing the source media into a plurality of content snippets, and generating a plurality of index components, each index component corresponding to a respective one of the content snippets.

The operations can further include determining a multi-tier frame-buffering technique, of a plurality of optional multi-tier frame-buffering techniques, to use for processing the source media and transferring the media data, as processed, to the host device.

The operations may further include sending the content snippets and the index components to the host device, according to the determined frame-buffering technique, for processing at the host device for rendering the media.

The plurality of optional multi-tier frame-buffering techniques consists of a circular frame-buffering technique and a single-file frame-buffering technique, referenced above and described more below.

Other aspects of the present technology will be in part apparent and in part pointed out hereinafter.

### DESCRIPTION OF THE DRAWINGS

FIG. 1 illustrates schematically an environment in which the present technology is implemented, including a portable system and a host device.

FIG. 2 illustrates operations of an algorithm programmed at the portable system of FIG. 1.

FIG. 3 illustrates operations of an algorithm programmed at the host device of FIG. 1.

FIG. 4 illustrates schematically a circular framebuffer transfer and real-time display process, synchronized by a multi-tiered, event-based, arrangement.

FIG. 5 shows an alternative view of the arrangement of FIG. 4, in a manner emphasizing a circular nature of the arrangement.

FIG. 6 shows a chart indicating an event-based timing by which circular files are written and read.

FIG. 7 shows a graph corresponding to the chart of FIG. 6, showing an amount by which consecutive circular files are read over time before a next file is written.

The figures are not necessarily to scale and some features may be exaggerated or minimized, such as to show details of particular components. In some instances, well-known components, systems, materials or methods have not been described in detail in order to avoid obscuring the present disclosure.

In the figures, like numerals are used to refer to like features.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model, or pattern.

Specific structural and functional details disclosed herein are not to be interpreted as limiting, but merely as a basis for the claims and as a representative basis for teaching one skilled in the art to employ the present disclosure.

While the present technology is described primarily herein in connection with automobiles, the technology is not limited to automobiles. The concepts can be used in a wide variety of applications, such as in connection with aircraft and marine craft, and non-transportation industries such as with televisions.

Other non-automotive implementations can include plug-in peer-to-peer, or network-attached-storage (NAS) devices.

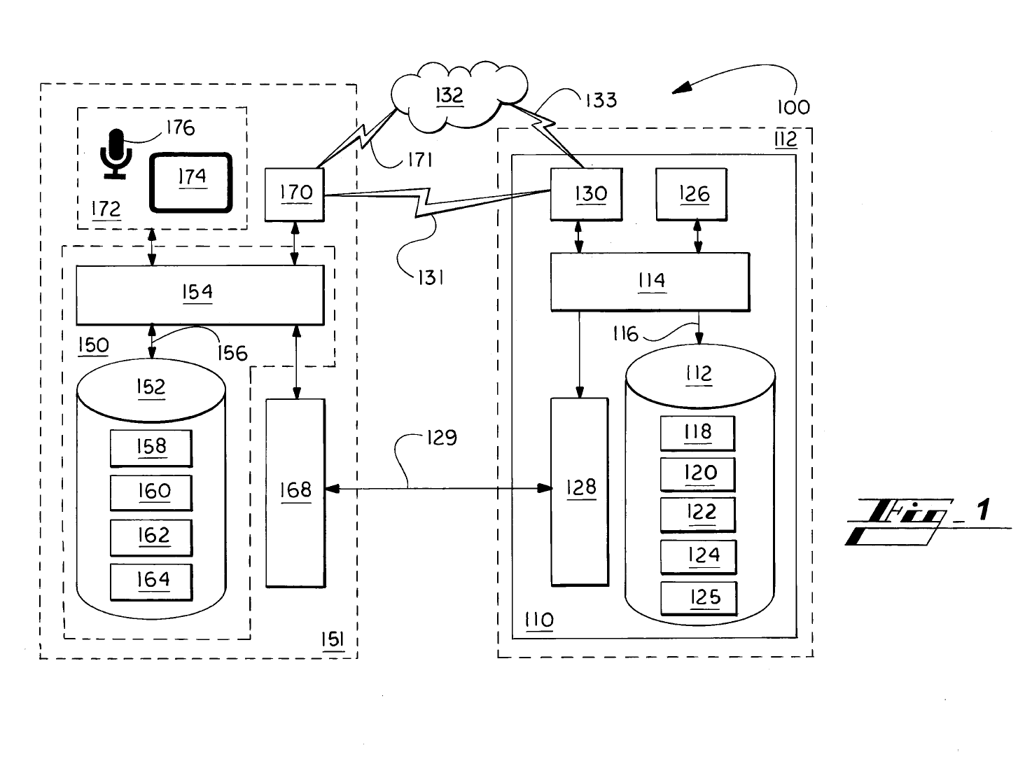

### I. FIG. 1—TECHNOLOGY ENVIRONMENT

FIG. 1 illustrates schematically an arrangement or environment 100 in which the present technology is implemented. The environment 100 includes a portable apparatus, system, or device 110 and a host apparatus, system, or device 150. For clarity, and not to limit scope, the portable apparatus 110 is referred to primarily herein as a portable system, and the host apparatus 150 as a host device. In some embodiments, the portable system and host device 110, 150 are a consolidated system 100.

The portable system 110 can take any of a variety of forms, and be referenced in any of a variety of ways—such as by peripheral device, peripheral system, portable peripheral, peripheral, mobile system, mobile peripheral, portable system, and portable mass-storage system.

The portable system 110 can be portable based on being readily removable, such as by having a plug-in configuration, for example, and/or by being mobile, such as by being configured for wireless communications and being readily carried about by a user. The portable system 110 can include a dongle, or a mobile communications device such as a smart phone, as just a couple examples.

Although connections are not shown between all of the components of the portable system 110 and of the host device 150 in FIG. 1, the components can interact with each other in any suitable manner to carry out system functions.

The portable system 110 includes a non-transitory hardware storage device 112. The hardware storage device 112 can be referred to by other terms, such as a memory, or computer-readable medium, and can include, e.g., volatile medium, non-volatile medium, removable medium, and non-removable medium. The term hardware storage device and variants thereof, as used in the specification and claims, refer to tangible or non-transitory, computer-readable storage devices. The component is referred to primarily herein as a hardware storage device 112, or just a storage device 112 for short.

In some embodiments, the storage device 112 includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The portable system 110 also includes a processing hardware unit 114 connected or connectable to the hardware storage device 112 by way of a communication link 116, such as a computer bus.

The processing hardware unit 114 can be referred to by other terms, such as computer processor, just processor, processing hardware unit, processing hardware device, processing hardware system, processing unit, processing device, or the like.

The processor 114 could be or include multiple processors, which could include distributed processors or parallel processors in a single machine or multiple machines. The processor 114 can include or be a multicore unit, such as a multicore digital signal processor (DSP) unit or multicore graphics processing unit (GPU).

The processor 114 can be used in supporting a virtual processing environment. The processor 114 could include a state machine, application specific integrated circuit (ASIC), programmable gate array (PGA) including a Field PGA (FPGA), DSP, GPU, or state machine. References herein to processor executing code or instructions to perform operations, acts, tasks, functions, steps, or the like, could include the processor 114 performing the operations directly and/or facilitating, directing, or cooperating with another device or component to perform the operations.

The portable system 110 in various embodiments comprises one or more complimenting media codec components, such as a processing or hardware component, and a software component to be used in the processing. The hardware or processing component can be a part of the processing device 114.

The hardware storage device 112 includes computer-executable instructions or code 118. The hardware storage device 112 in various embodiments stores at least some of the data received and/or generated, and to be used in processing, in a file-based arrangement corresponding to the code stored therein. For instance, when an FPGA is used, the hardware storage device 112 can include configuration files configured for processing by the FPGA.

The computer-executable code 118 is executable by the processor 114 to cause the processor 114, and thus the portable system 110, to perform any combination of the functions described herein regarding the portable system.

The hardware storage device 112 includes other code or data structures, such as a file sub-system 120, and a framebuffer capture component 122.

As mentioned, the portable system 110 in various embodiments comprises one or more complimenting media codec components, such as a processing, or hardware component, and a software component to be used in the processing. The software media codec component is indicated by reference numeral 124.

As also mentioned, a framebuffer can be a transferred video source, such as in the form of a data content package, captured by the framebuffer capture component 122.

The file sub-system 120 can include a first level cache and in some implementations also a second level cache.

In some embodiments, the hardware storage device 112 includes code of a dynamic programming language 125, such as JavaScript, Java or a C/C++ programming language. The host device 150 includes the same programming language, which is indicated in FIG. 1 by reference numeral 164. The component 164 of the host device 150 in some implementations includes an application framework, such as the media application mentioned and/or an application manager for managing operations of the media application at the host device 150.

The programming language code can define settings for communications between the portable system 110 and the host device 150, such as parameters of one or more application program interfaces (APIs) by which the portable system 110 and the device 150 communicate.

The portable system 110 in some embodiments includes at least one human-machine interface (HMI) component 126. For implementations in which the interface component 126 facilitates user input to the processor 114 and output from the processor 114 to the user, the interface component 126 can be referred to as an input/output (I/O) component. As examples, the interface component 126 can include, or be connected to a sensor for receiving user input, and include or be connected to a visual or audible indicator such as a light, digital display, or tone generator, for communicating output to the user.

The interface component 126 is connected to the processor 114 for passing user input received as corresponding signals to the processor. The interface component 126 is configured in any of a variety of ways to receive user input. In various implementations the interface component 126 includes at least one sensor configured to detect user input provided by, for instance, a touch, an audible sound or a non-touch motion or gesture.

A touch-sensor interface component can include a mechanical actuator, for translating mechanical motion of a moving part such as a mechanical knob or button, to an electrical or digital signal. The touch sensor can also include a touch-sensitive pad or screen, such as a surface-capacitance sensor.

For detecting gestures, the interface component 126 can include or use a projected-capacitance sensor, an infrared laser sub-system, a radar sub-system, or a camera sub-system, by way of examples.

The interface component 126 can be used to affect features—e.g., functions, settings, or parameters—of one or both of the portable system 110 and the host device 150 based on user input. Signals or messages corresponding to inputs received by the interface component 126 are transferred to the processor 114, which, executing code (e.g., code 118) of the hardware storage device 112 can set or alter a feature at the portable system 110. Inputs received can also trigger generation of a communication, such as an instruction or message, for the host device 150, and sending the communication to the host device 150 for setting or altering a feature of the device 150.

The portable system 110 is in some embodiments configured to connect to the host device 150 by hard, or wired connection 129. Such connection is referred to primarily herein as a wired connection in a non-limiting sense. The connection can include components connecting wires, such as the USB plug-and-port arrangement described.

In some other embodiments, the connection is configured with connections according to higher throughput arrangements, such as using an HDMI port or a VGA port.

The portable system 110 is in a particular embodiment configured as a dongle, such as by having a data-communications plug 128 for connecting to a matching data-communications port 168 of the host device 150, as indicated in FIG. 1. As provided, the portable system 110 is in some embodiments a portable mass-storage system. The portable system 110 is configured in various embodiments to operate any one or more of a variety of types of computer instructions that it may be programmed with for dynamic operations and/or that it may receive for dynamic processing at the system 110.

An example data-communications plug 128 is a USB plug, for connecting to a USB port of the host device 150.

In some embodiments, the portable system 110 is configured for wireless communications with the host device 150 and/or a system 132 external to the portable system 110, such as a remote network or database. A wireless input or input/output (I/O) device—e.g., transceiver—or simply a transmitter, is referenced by numeral 130 in FIG. 1. Wireless communications with the host device 150 and external system 132 are referenced by numerals 131, 133, respectively.

The wireless device 130 can communicate with any of a wide variety of networks, including cellular communication networks, satellite networks, and local networks—e.g., roadside-infrastructure or other local-wireless transceivers, beacons or hotspots. The wireless device 130 can also communicate with near-field communication (NFC) devices to support functions such as mobile payment processing, or communication setup/handover functions, or any other use cases that are enabled by NFC. The wireless device 130 can include, for example, a radio modem for communication with cellular communication networks.

The remote system 132 can thus in various embodiments include any of cellular communication networks, road-side infrastructure or other local networks, for reaching destinations such as the Internet and remote servers. The remote server may be a part of or operated by a customer-service center or system, such as the OnStar ® system (ONSTAR is a registered trademark of Onstar LLC of Detroit, Mich.).

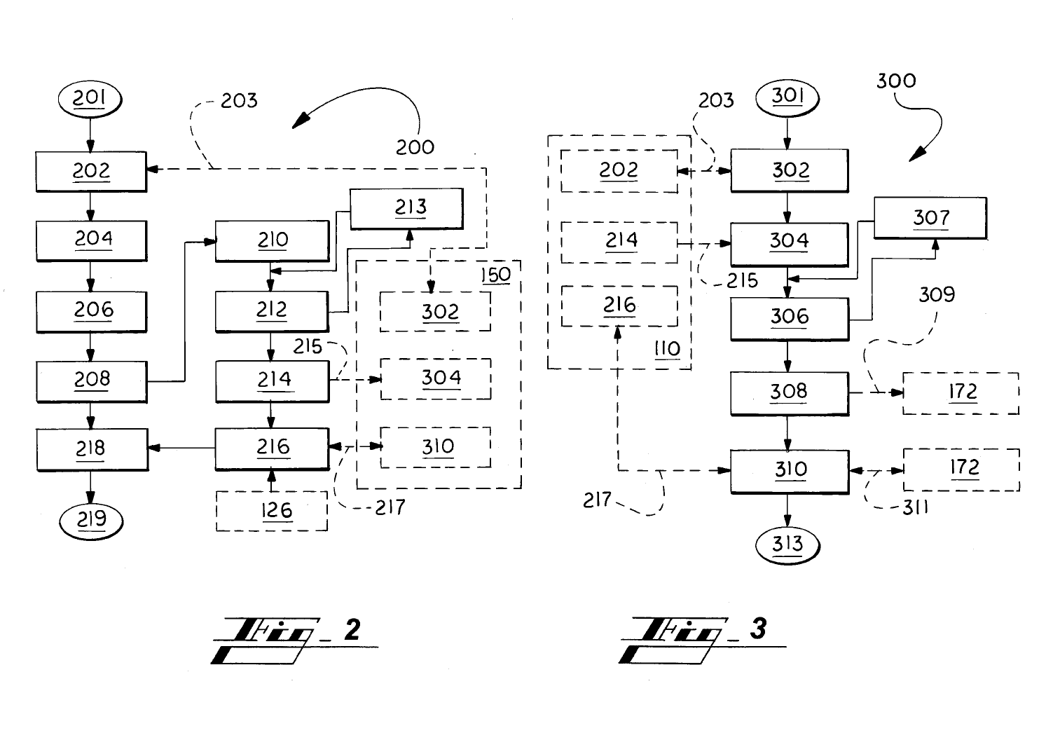

Other features and functions of the portable system 110 are described below, primarily in connection with the algorithm of FIG. 2.

The host device 150 is, in some embodiments, part of a greater system 151, such as an automobile.

As shown, the host device 150 includes a hardware storage device 152. The hardware storage device 152 can be referred to by other terms, such as a memory, or computer-readable medium, and can include, e.g., volatile medium, non-volatile medium, removable medium, and non-removable medium. The term hardware storage device and variants thereof, as used in the specification and claims, refer to tangible or non-transitory, computer-readable storage devices. The component is referred to primarily herein as a hardware storage device 152, or just a storage device 152 for short.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The host device 150 also includes an embedded computer processor 154 connected or connectable to the storage device 152 by way of a communication link 156, such as a computer bus.

The processor 154 can be referred to by other terms, such as processing hardware unit, processing hardware device, processing hardware system, processing unit, processing device, or the like.

The processor 154 could be or include multiple processors, which could include distributed processors or parallel processors in a single machine or multiple machines. The processor 154 can include or be a multicore unit, such as a multicore digital signal processor (DSP) unit or multicore graphics processing unit (GPU).

The processor 154 can be used in supporting a virtual processing environment. The processor 154 could include a state machine, application specific integrated circuit (ASIC), programmable gate array (PGA) including a Field PGA (FPGA), DSP, GPU, or state machine. References herein to processor executing code or instructions to perform operations, acts, tasks, functions, steps, or the like, could include the processing device 154 performing the operations directly and/or facilitating, directing, or cooperating with another device or component to perform the operations.

The hardware storage device 152 includes computer-executable instructions or code 158. The hardware storage device 152 in various embodiments stores at least some of the data received and/or generated, and to be used in processing, in a file-based arrangement corresponding to the code stored therein. For instance, when an FPGA is used, the hardware storage device 112 can include configuration files configured for processing by the FPGA.

The storage device 152 includes computer-executable instructions, or code 158. The computer-executable code 158 is executable by the processor 154 to cause the processor, and thus the host device 150, to perform any combination of the functions described in the present disclosure regarding the host device 150.

The host device 150 includes other code or data structures, such as a file sub-system 160, a dynamic-programming-language application framework 162, such as JavaScript, Java or a C/C++ programming language.

The file sub-system 160 can include a first level cache and a second level cache. The file sub-system 160 can be used to store media, such as video or image files, before the processor 154 publishes the file(s).

The dynamic-programming-language (e.g., JavaScript, Java or a C/C++ programming language) application framework 162 can be part of the second level cache. The dynamic-programming-language is used to process image data received from the portable system 110. The programming language code can define settings for communications between the portable system 110 and the host device 150, such as parameters of one or more APIs.

The host device 150 includes or is in communication with one or more interface components 172, such as an HMI component. For implementations in which the components 172 facilitate user input to the processor 154 and output from the processor 154 to the user, the components can be referred to as input/output (I/O) components.

For output, the interface components 172 can include a display screen 174, which can be referred to as simply a display or screen, and an audio output such as a speaker. In a contemplated embodiment, the interface components 172 include components for providing tactile output, such as a vibration to be sensed by a user (e.g., an automobile driver), such as by way of a steering wheel or vehicle seat.

The interface components 172 are configured in any of a variety of ways to receive user input. The interface components 172 can include for input to the host device 150, for instance, a mechanical or electro-mechanical sensor device such as a touch-sensitive display, which can be referenced by numeral 174, and/or an audio device 176 such as an audio sensor—e.g., microphone—or audio output such as a speaker. In various implementations, the interface components 172 includes at least one sensor. The sensor is configured to detect user input provided by, for instance, touch, audibly, and/or by user non-touch motion, e.g., by gesture.

A touch-sensor interface component can include a mechanical actuator, for translating mechanical motion of a moving part such as a mechanical button, to an electrical or digital signal. The touch sensor can also include a touch-sensitive pad or screen, such as a surface-capacitance sensor. For detecting gestures, an interface component 172 can use a projected-capacitance sensor, an infrared laser sub-system, a radar sub-system, or a camera sub-system, for example.

The interface component 172 can be used to affect functions and setting or parameters of the one or both of the portable system 110 and the host device 150 based on user input. Signals corresponding to inputs received by the interface component 172 are passed to the processor 154, which, executing code of the storage device 152, sets or alters a function at the host device 150, or generates a communication for the portable system 110, such as an instruction or message, and sends the communication to the portable system 110 for setting or altering the function of the portable system 110.

The host device 150 is in some embodiments configured to connect to the portable system 110 by the wired connection 129 mentioned. The host device 150 is in a particular embodiment configured with, or connected to a data-communications port 168 matching the data-communications plug 128 of the portable system 110 for communicating by way of the wired link 129. An example plug/port arrangement provided is the USB arrangement mentioned.

As provided, the connection is in some other embodiments configured with connections according to higher throughput arrangements, such as using an HDMI port or a VGA port.

In some embodiments, the host device 150 is configured for wireless communications 131 with the portable system 110. A wireless input, or input/output (I/O) device—e.g., transceiver—is referenced by numeral 170 in FIG. 1. The processor 154, executing code of the storage device 152, can wirelessly send and receive information, such as messages or packetized data, to and from the portable system 110 and the remote system 132, by way of the wireless input, or I/O device 170 as indicated by numerals 131, 171, respectively.

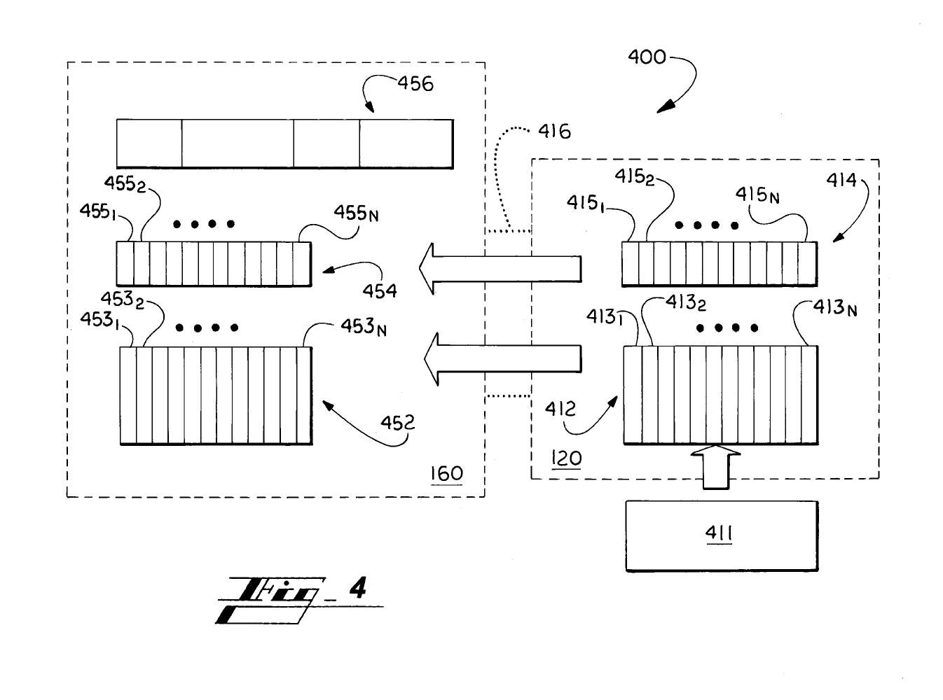

Other features and functions of the host device 150 are described below, primarily in connection with the algorithm of FIG. 3.

### II. FIGS. 2-5—ALGORITHMS AND FUNCTIONS

The algorithms by which the present technology is implemented are now described in more detail. The algorithms are outlined by flow charts arranged as methods 200, 300 in FIGS. 2 and 3.

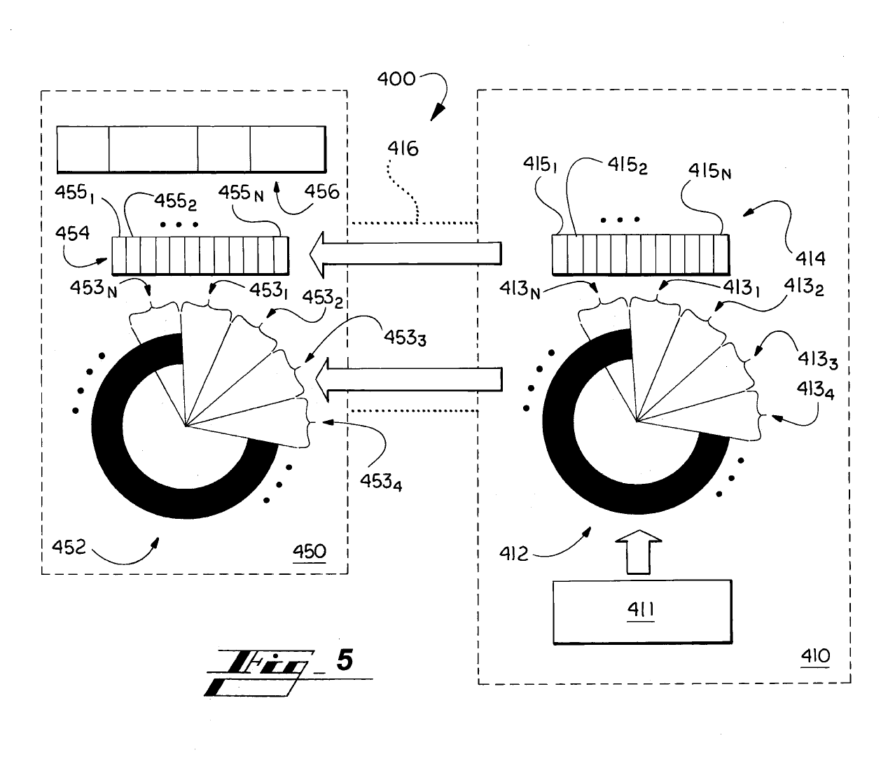

FIG. 2 illustrates operations of an algorithm programmed at the portable system 110 of FIG. 1. FIG. 3 illustrates operations of an algorithm programmed at the host device 150 of FIG. 1. FIG. 4 shows schematically a circular framebuffer arrangement 400 between respective file sub-systems 410, 450 (corresponding to respective file sub-systems 120, 160) of the portable system 110 and the host device 150. And FIG. 5 shows an alternative view of the same arrangement as that of FIG. 4, in a manner emphasizing a circular nature of the arrangement.

It should be understood that operations of the methods 200, 300 are not necessarily presented in a particular order and that performance of some or all the operations in an alternative order is possible and contemplated.

The operations have been presented in the demonstrated order for ease of description and illustration. Operations can be added, omitted and/or performed simultaneously without departing from the scope of the appended claims.

It should also be understood that the illustrated algorithms 200, 300 can be ended at any time. In certain embodiments, some or all operations of this process, and/or substantially equivalent operations are performed by execution by the processors 114, 154 of computer-executable code of the storage devices 112, 152 provided herein.

II.A. Portable System Operations—FIGS. 2 and 4

The algorithm 200 of FIG. 2 is described primarily from the perspective of the portable system 110 of FIG. 1.

The algorithm 200 commences 201 and flow proceeds to the first operation 202 whereat the portable system 110—i.e., the processor 114 thereof executing code stored at the system storage 112—is placed in communication with the host device 150. Connecting with the host device 150 can include connecting by wire 129 (e.g., plug/port and wires) or wirelessly 131, as described above in connection with the arrangement 100 of FIG. 1. Example host devices 150 include a head unit, or an on-board computer, of a transportation vehicle, such as an automobile.

The portable system 110 is in some embodiments configured to connect to the host device 150 by wired connection, referenced by numeral 129 in FIG. 1 and also by numeral 203 in FIG. 2. Corresponding activity of the host device 150 for this interaction 202 is described further below in connection with FIG. 3, and particularly block 302 of FIG. 3.

FIG. 4 shows aspects of the respective file sub-systems 120, 160 of the portable system 110 and the host device 150.

The portable system 110 is in a particular embodiment configured as a dongle, such as by having a data-communications plug 128—e.g., USB plug—for connecting to a matching port 168 of the host device 150. For communications between the portable system 110 and the host device 150, each can include in their respective storage devices 112, 512, a protocol operable with the type of connection. With the USB plug/port example, the protocol can be a USB mass-storage-device-class (MSC) computing protocol. Other, more advanced, USB or other, protocols, including Media Transfer Protocol (MTP), could also be supported.

The portable system 110 is in some embodiments configured to connect to the host device 150 by wireless connection, referenced by numeral 131 in FIG. 1, and also by numeral 203 in FIG. 2.

The portable system 110 connected communicatively with the host device 150 performs a handshake process with the host device 150, which can also be considered indicted by reference numeral 203 in FIG. 2.

Operation 202 establishes a channel by which data and communications such as messages or instructions can be shared between the portable system 110 and the host device 150.

For embodiments in which both devices include a dynamic programming language, such as JavaScript, the operation 202 can include a handshake routine between the portable system 110 and the host device 150 using the dynamic programming language.

Flow proceeds to block 204 whereat the processor 114 receives, e.g., by way of the wireless communication component 130, a source media file, such as streaming video, from a source, such as a remote video source. The remote source can include a server of a customer-service center or system, such as a server of the OnStar ® system.

Turning to FIG. 4, the data content is received from a source such as a framebuffer 411.

In various embodiments, the source media file referenced is a virtual file, such as in the form of a link or a pointer linked to a memory location containing particular corresponding media files, or a particular subset of the media files.

While the technology can be used to transfer and display render in real time—e.g., render for displaying or display purposes—various types of media files, including those with or without video, and with or without audio, the type of file described primarily herein is a video file representing a graphic output, or data for being output as a corresponding graphical display at a display screen, which in various embodiments does and does not include audio. References in the present disclosure to streaming video, video files, or the like, should for various embodiments be considered to also refer to like embodiments that include any of the various media file types possible.

The operation can include receiving the media—e.g., file—in one piece, or receiving separate portions simultaneously or over time.

In a contemplated embodiment, the video file is received from a local source, such as a virtual video file linked to the framebuffer or associated in the system—e.g., system memory—with the display screen. In embodiments, a primary, if not sole, video source is the framebuffer.

The local source can include, for instance, a smart phone or other mobile device that either receives the video file from a remote source and passes it on to the portable system 110, or has the video stored at the local source. Transfer from the local source to the portable system 110 can be by wire or wireless.

In various embodiments the video stream has any of a variety of formats, such as .mpeg, .wmv, or .avi formats, just by way of example.

Flow proceeds to block 206 whereat the processor 114 divides the source video stream, or other visual media file(s), into a plurality of indexed image components—e.g., consecutively-ordered image components. In various embodiments the image components have any of a variety of formats, such as a .jpeg format for example.

While the image components for various implementations are equal-sized, in other implementations, every image component is not the same size.

As mentioned, the portable system 110 in some embodiments has, in the hardware storage device 112, code of a dynamic programming language 125, such as JavaScript, Java or a C/C++ programming language. The language can be used in system 110 operations including image-processing operations such as the present function of dividing the video stream—e.g., video file—into consecutive image components.

The image components together can be referred to as a data-content package.

The number (N) of image components can be any in a wide range. Only by way of example, the number (N) can be in the range of about 2,500 to about 3,500. In contemplated embodiments, the number (N) is less than 2,500 or above 3,500.

In various embodiments, at block 208, the processor 114 stores the data-content package 412 (FIGS. 4, 5) to a portion of memory 112 at the portable system 110, such as to a circular buffer, referenced in FIG. 5 by numeral 412. In this case, the framebuffer 122 can act more as a local content source rather than as a destination.

Turning again to FIG. 4, wherein the data content is indicated by reference numeral 412, and the constituent image components are referenced by numerals 413₁-413_{N}. The package 412 is stored in a first level cache of the portable system 110. FIG. 5 shows the same arrangement as that in FIG. 4 in a different format, emphasizing the circular-file aspects of the arrangement.

In a contemplated embodiment, the processor 114 at block 208 stores the data-content package 412 (FIGS. 4, 5) to the framebuffer, or framebuffer capture component, referenced in FIG. 1 by numeral 122. In this case, the framebuffer 122 acts more as a buffer or local destination before the data is processed further and transferred to the host device.

At block 210, the processor 114 generates a meta-index package 414 (FIGS. 4 and 5) comprising a plurality of meta index components 415₁-415_{N}. Each meta index component 415 (415₁-415_{N}) corresponds to a respective one of the image components 413 (413₁-413_{N}) Each meta index component 415 is configured to refer, or point, to its corresponding image component 413 (413_{1-N}). The first meta index component 415₁ indicates or points to the first image component 413₁, the second meta index component 415₂ indicates the second image component 413₂, and so on. The meta index components 415 thus number (N) like the image components 413.

The meta index components 415 can be the same as or similar to directory entry structures, such as that of a file allocation table (FAT) system.

At block 212, the processor 114 stores the meta index 414 at the portable system 110. The meta index 414 is also stored at the first level cache of the portable system 110.

As provided, operations of the method 200 can be performed in any order, and operations can be combined to a single step, or separated into multiple steps. Regarding the generating operations 206, 210 and storing operations 208, 212, for instance, the generating operations and/or the storing can be performed in respective single steps. The portable system 110 can store the data-content package 412 and the meta-index package 414 to the hardware storage device 112, in single operation, for instance. And the packages 412, 414 can be part of the same packet, stream, or file, or stored or transferred to the host device 150 separately.

In some embodiments, the operations include one or more real-time adjustment functions, referenced by numeral 213 in FIGS. 2 and 307 in FIG. 3. In the operation at block 213, the processor 114, executing system code, adjusts or manipulates a linkage relationship between the data-content package and the meta-index package in real time at the host system. The host device 150 can perform a similar real-time adjustment, at block 307, in addition to or instead of such adjustment at the portable system 110 at block 213.

As an example of what the adjustment function can include, the adjustment can change particular image content that is associated with a particular meta index. For determining how to adjust the linkage, the processor 114 can use as input its local clock and local copy of the physical address of the video stream. By doing so, static content represented by, for instance, USB mass storage protocol, becomes dynamic, and real-time video streaming through USB mass storage protocol is realized. Benefits of this manipulation include rendering dynamic screen output without requiring advanced classes of USB devices. The process can thus be applied with a much broader range of devices having basic USB mass storage capabilities.

At block 214, the processor 114 sends the data-content package 412 and corresponding meta-index package 414 to the host device 150. The transfer is referenced by reference numeral 215 in FIG. 2. Corresponding activity of the host device is described further below in connection with FIG. 3, and particularly at block 304 there.

The data-content package 412 and corresponding meta-index package 414 can be sent in a single communication or transmission, or by more than one communication or transmission. The mechanism is referred to at times herein as a packet, stream, file, or the like, though it may include more than one packet or the like.

In one embodiment, each image-component/meta-index-component pair is sent by the processor 114 to the host device 150 individually, in separate transmissions, instead of in packages 412, 414 with other image component/meta index component pairs. This embodiment can be referred to as a single-image file arrangement or management, by way of example.

The arrangements involving transfer of one or more components of data content at a time and one or more corresponding components of meta index (including circular file and single file arrangements) can be referred to as a multi-tiered arrangement, the meta index features being a first tier corresponding to a second tier of image data features. The packet(s) is configured and sent to the host device 150 for publishing of the image components sequentially, in accord with an order of the meta-index package. The host device 150 publishes the image components to display render streaming video, corresponding to the original, source video stream, by way of the host device 150 and a display device 174.

In a contemplated embodiment, the portable system 110 is configured to determine in real time which of the circular file arrangement and the single-file arrangement to use. This type of determination can be referred to by any of various terms, such as dynamic, real-time, or adaptive—e.g., dynamic selection amongst framebuffering algorithms or techniques.

Variables for the determining between framebuffering algorithms can include, for instance, one or more characteristics of the media—e.g., video—received for processing (e.g., dividing, storing, and sending). The variable could also include an identification, or identity, of a relevant application running at the host device 150 to publish the resulting video, an application category to which the application belongs, a type of application, or the like.

An identity of the relevant application can be indicated in any of a variety of ways. As examples, the application can be identified by application name, code, number, or other indicator.

Example application categories include live-video-performance, stored-video, video game, text/reader, animation, navigation, traffic, weather, Internet radio, audio/music playback, vehicle-maintenance and/or driver-status monitoring application, and any infotainment application.

In a contemplated embodiment, distinct categories include applications of a same or similar type or genre based on characteristics distinguishing the applications. For instance, a first weather application could be associated with a first category based on its characteristics while a second weather application is associated with another category based on its characteristic. To illustrate, below is a list of six (6) example categories. The phrasing heavy, medium, and light indicate relative amounts of the format of media (e.g., moving map, video, or text) that is expected from, e.g., historically provided by, applications.
1. Heavy moving map/heavy imaging/light video/light text (e.g., some weather apps)
2. Light moving map/medium imaging/light video/heavy text (e.g., some other weather apps)
3. Heavy moving map/medium text (e.g., some navigation apps)
4. Medium moving map/high text (e.g., some other navigation apps)
5. Light text/heavy imaging and/or video (e.g., some e-reading apps, such as children's-reading or visual education e-reading applications)
6. Heavy text/light imaging (e.g., some other e-reading apps).

It should be appreciated that such categorization is merely an example, and other approaches of application categorization based on application characteristics could be used.

The application characteristic (e.g., application identity or category) can be obtained in any of a variety of ways. The characteristic is in various embodiments predetermined and stored at the hardware storage device 112 of the portable system 110 or predetermined and stored at the storage device 152 of the host device 150.

In various embodiments, the application characteristic is indicated in one or more files being processed or transferred. The file can contain a lookup table, mapping each of various applications (e.g., a navigation application) to a corresponding application characteristic(s). The file can be stored at the storage device 152 or the host device 150, or at another system, such as a remote server, which can be referenced by numeral 132 in FIG. 1.

In a contemplated embodiment, an application category relates to a property or type of the subject application. In a contemplated embodiment, the application category is determined in real time based on activities of the application instead of by receiving or retrieving an indicator of the category. The processor 114 can determine the application category to be video, weather, or traffic, for instance, upon determining that the visual media being provided is video, or a moving map overlaid with weather or traffic, respectively.

In a contemplated embodiment, determining the category includes creating a new category or newly associating the application with an existing application. While the application may not have been pre-associated with a category, the processor 114 may determine that the application has a particular property or type lending itself to association with an existing category. In a particular contemplated embodiment, the instructions 118 are configured to cause the processor 114 to establish a new category to be associated with an application that is determined to not be associated with an existing category. In one embodiment, a default category exists or is established to accommodate such applications not matching another category.

These are example factors considered in dynamically selecting amongst the framebuffering techniques. The system in various embodiments is configured to select one of the framebuffering techniques based on one or more of the factors. In a contemplated embodiment, a data table or chart, or other relational data structure or arrangement, indicates one or more pre-established relationships, between one or more of the factors, and the preferred framebuffering technique to use under the circumstances. As examples:
the code is in some embodiments configured such that the circular framebuffering technique is preferred when factors indicate that a subject application, to use the data being transferred, is any or all of (1) a high-frame-rate application, like those executing video streaming or animation, (2) a latency-sensitive application, like one involving dragging and zooming of a map in execution, and (3) a computationally intensive applications, such as an application involving vehicle-data analytics; and
the code is in some embodiments configured such that the single-file framebuffering technique is preferred when factors indicate any or all of (1) a low frame rate application, such as basic navigation (e.g., display of map), web browsing, weather, etc., (2) a driving situation or environment for which frame rate usage for applications must be restricted, (3) the vehicle has an engine-off status, wherein vehicle power consumption is strictly limited at the vehicle, (4) overlay situation, wherein a high- or higher-priority message is provided atop another display of the portable system, the overlay being generally data, or data and still icons or images, and (5) the vehicle is in a dormant status, sleeping status, of the like, wherein the software running at the host device may temporarily not communicate with the portable system.

An efficient and effective type of synchronization, not requiring synchronized clocks, is provided by this arrangement of sending a meta index 414 of meta index components 415 corresponding in order to image components 413 of a data-content package 412 for sequential display rendering of the image components 413 in accord with the index components 415.

The processing, or reading, of each image component is triggered by the reading first of the corresponding meta index component. Each next index component (e.g., 415₂) is read following processing of a prior image component (e.g., 413₁), and points the processor 154 to read its corresponding image component (e.g., 413₂). The synchronization can be referred to as event-based synchronization, whereby none of the image components will be processed out of order. The event-based synchronization obviates the need for expensive clock or time synchronization components.

The synchronization can also be referred to as distributed device synchronization, as it involves functions of both devices, working together: the generating and sending of the index/data packages according to the present technology at the portable system 110, and the receiving and ordered display rendering of the packages at the host device 150.

The process 200 or portions thereof can be repeated, such as in connection with a new stream or file associated with a new video, or with subsequent portions of the same video used to generate the first image components and meta index components. The subsequent operations would include preparing a second data-content package and corresponding second meta-index package in the ways provided above for the first packages.

As referenced, the portable system 110 and the host device 150 can further be configured for bidirectional communications, which can be referred to as duplexing. The two-way communications can, in some implementations, be made simultaneously.

Each of the portable system 110 and the host device 150 can also be configured for multiplexing, inverse multiplexing, and the like to facilitate the efficient and effective transfer and real-time display of relatively high-throughput data between them.

As provided, in various embodiments, the configuration is arranged to facilitate communications according to the TDMA channel-access method.

At operation 216, the portable system 110 generates, identifies (e.g., retrieves), receives, or otherwise obtains instructions or messages, such as orders or requests for changing of a feature, such as a setting or function. For adjusting a feature, such as a setting or function, of the portable system 110, based on an instructions obtained (e.g., received, retrieved, or generated), the processor 114 executes the instruction. For adjusting a feature of the host device 150, the processor 114 sends the instruction or message to the host device 150. Regarding the operation is indicated by reference numeral 216 in FIG. 2, with the communication channel and the communication being indicated by 217.

In embodiments, the processing hardware device 154 of the host device 150, executing, for instance, the dynamic programming language 164 also captures user inputs, for example, touches, gestures and speech received by way of a machine-user interface 172, translates them to data streams—byte streams, for instance—and then sends them to the portable system 110 through connection 129 or 131, for example.

In various embodiments, the processor 114 receives, such as by way of the wireless communication component 130, a communication, such as an instruction or message from the host device 150. The operation is also indicated by reference numeral 216 in FIG. 2, with the communication channel and the communication being indicated by 217.

As mentioned, the transfer 217 is an example of data transfer by way of a second, or back channel of the bidirectional arrangement. Back-channel communications can be, but is not in every implementation, initiated by user input to the portable system 110.

Communications 217 from the host device 150 can take any of a variety of forms, such as by being configured to indicate a characteristic, function, parameter, or setting of the portable system 110. The communication 217 can indicate a manner by which to establish the characteristic, function, parameter or setting at the portable system 110, or to alter such previously established at the portable system 110.

In various embodiments, the portable system 110 can be personalized, such as by various features—e.g., settings or user preferences. These can be programmed to the portable system 110 by any of a variety of methods, including by way of the host device 150—via the second, back, channel mentioned, for instance—a personal computer (now shown), a mobile phone, or the like.

In some embodiments, default settings or preferences of the portable system 110 are provided before any personalization is performed. The settings or preferences for personalization of the portable system 110 can include any of those described herein, such as a manner by which the portable system 110 processes incoming video.

Example features include (i) a setting controlling a size of equal-sized image snippets into which to divide the incoming video, (ii) a setting controlling a number of image components, or snippets, into which to divide incoming video to form each data-image package, and so a number of corresponding meta index components of a meta-index package, (iii) a playback feature—e.g., setting—stored at the portable system 110, which can be controlled by instruction from the host device 150, and affects a manner by which the portable system 110 delivers data-content packages to the host device 150, such as a timing, speed, rate, or size of the data or data package sent, and (iv) a setting affecting a speed, rate, or quality by which the portable system 110 processes incoming video, such as affecting a setting controlling reading of incoming streaming video or writing of the image snippets formed based on the video. The speed, rate, or quality of processing can affect other processes (e.g., making available bandwidth for a VOIP call), or video-viewing experience, such as playback qualities at the host device 150.

While the features can take other forms without departing from the scope of the present technology, in various embodiments, the features include at least one setting selected from a group consisting of a quality of the image components formed at the portable system 110 and a playback setting at the host device 150 or at the portable system 110. Example image quality characteristics include a level of zoom, brightness, or contrast.

The playback feature—e.g., setting or characteristic—at the host device 150 can affect (a) a speed by which the video display is rendered, (b) a direction by which the video display is rendered, (c) whether the video is rendered or played, or not rendered or played at all, (d) fast-forward (e.g., a fast-forward mode), (e) rewind (e.g., a rewind mode), (f) pause (e.g., a pause mode), stop (e.g., a stop mode), (g) play (e.g., a play mode), (h) or rate of video play.

As another example feature, a setting of the portable system 110 can include a setting controlling whether a single-image file arrangement or a circular-file arrangement should be used, whereby the portable system 110 would send image snippets, and corresponding index components, one at a time or together in a circular file, respectively.

The controlling setting, controlling whether a single-image file arrangement or a circular-file arrangement should be used, is in various embodiments performed in response to user input or triggered automatically, such as by events or sensor readings. By way of example, an engine-off event can in an embodiment trigger transitioning from the single-file arrangement to circular-file arrangement. In other examples, an engine-off event can in an embodiment trigger transitioning from the circular-file arrangement to single-file arrangement, or an engine-on event can in an embodiment trigger transitioning from the circular-file arrangement to single-file arrangement, or an engine-on event can in an embodiment trigger transitioning from the single-file arrangement to circular-file arrangement.

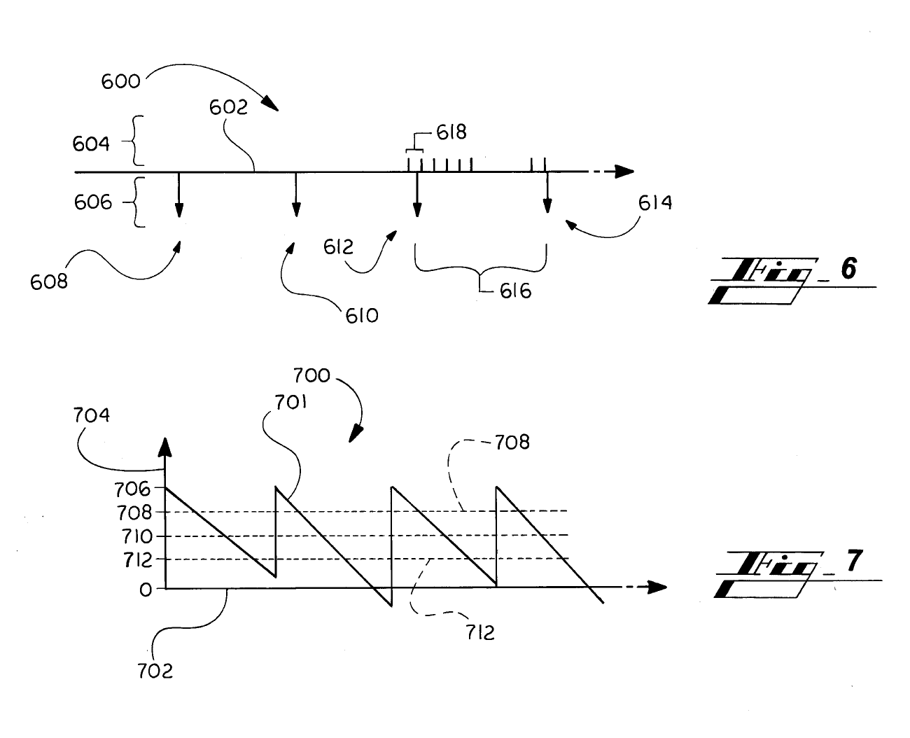

As another example feature, a setting of the portable system 110 and/or the host device 150 includes one or more fractional values, between 0 and 1, of full circular files, associated with a timing of reading and/or writing of the circular files. Example values are described further below, including in connection with FIGS. 6 and 7.

As another example, feature, the feature can include a setting affecting a linkage relationship between the data-content package and the meta-index package in real time at the remote portable system. Adjusting a linkage relationship is described further in connection with blocks 213 and 307.

At block 218, user input is received at the processor 114 of the portable system 110 by way of one or more user input, or I/O interfaces 126 (FIG. 1). As mentioned, the portable system 110 in some embodiments includes the at least one HMI component 126, such as a button, knob, touch-sensitive pad (e.g., capacitive pad), or microphone, configured to detect user input provided by touch, sound, and/or by non-touch motion, e.g., gesture.

The interface component 126 can be used to affect any features, including those mentioned—e.g., functions and settings or parameters—of one or both of the portable system 110 and the host device 150, based on user input provided to either the portable system 110 or the host device 150.

Thus, the processor 114, executing code of the hardware storage device 112 can generate or identify at least one instruction or message. The instruction can take any of a variety of forms, such as by being configured to indicate a feature, such as a characteristic, function, parameter, or setting, of the portable system 110, or to indicate a feature, such as a characteristic, function, parameter, or setting, of the host device 150. The instruction can further indicate a manner by which to establish a feature, such as a characteristic, function, parameter or setting of the portable system 110, or to alter such feature established.

The process 200 of FIG. 2 can end 219 or any portion of the process can be repeated.

II.B. Host Device System Operations—FIG. 3-5

The algorithm 300 of FIG. 3 is described primarily from the perspective of the host system or device 150 of FIG. 1. As provided, the device 150 can include or be a part of a head unit, or on-board computer, of a transportation vehicle, such as an automobile, for example.

The host device 150 can be connected by wire or wirelessly to the potable system 110.

The algorithm 300 begins 301 and flow proceeds to the first operation 302 whereat the host device 150—i.e., the processor 154 thereof executing code stored at the device storage 152—is placed in communication with the portable system 110. Connecting with the portable system 110 can include connecting by the wired or wireless connection 129, 131, shown.

The connection of block 302 can include a handshake process between the host device 150 and the portable system 110, which can also be considered indicted by reference numeral 203 in FIGS. 2 and 3. The process at operation 302 establishes a channel by which data and communications such as messages or instructions, can be shared between the portable system 110 and the host device 150.

In embodiments, during this handshake process, meta index components 415 are also exchanged based on, for example, USB mass storage device protocol.

For embodiments in which both devices include a dynamic programming language, such as JavaScript, Java or a C/C++ programming language, the operation 302 can include a handshake routine between the portable system 110 and the host device 150 using the dynamic programming language.

Flow proceeds to block 304 whereat the processor 154 receives from the portable system 110 the data-content package 412 and corresponding meta-index package 414 shown in FIGS. 4 and 5. The transmission is referenced above in connection with the associated portable-system operation 214 of FIG. 2, and referenced by numeral 215.

Receipt 304 of communications can be made along a forward channel of the bidirectional or arrangement mentioned, by which communications can be sent in both direction between the portable system 110 and the host device 150, including in some implementations simultaneously.

As mentioned, the data-content package 412 and corresponding meta-index package 414 can be sent in a single communication or transmission or by more than one communication or transmission. The mechanism is referred to at times herein as a packet, though it may include more than one packet, stream, or file.

In another embodiment, mentioned above in connection with FIG. 2, each image component/meta index component pair is received at the processor 154 from the portable system 110 individually, in separate transmissions, instead of in a packet with other image component/meta index component pairs. This embodiment can be referred to as a single-image file arrangement or management, by way of example.

Again, the arrangement, involving transfer of one or more components (e.g., components 413) of data content (412) at a time and one or more corresponding components (e.g., components 415) of meta index (414), can be referred to as a multi-tiered arrangement, the meta index features being a first tier corresponding to the image data features being the second tier.

The transfer can be performed by wired connection or wireless connection, which are indicated schematically by reference numerals 129 and 131 in FIG. 1, and by numeral 416 in FIGS. 4 and 5.

At block 306, the processor 154 stores the data-content package 412 and the index package 414 received to a portion of memory 152 at the host device 150, such as in memory 152 associated with the dynamic-programming-language (e.g., JavaScript, Java or a C/C++ programming language) application framework 162. The data-content package 412, its constituent parts being the data snippets—e.g., image components 413, and the index package 414, and its constituent index components 415, are referenced in FIG. 4 by numerals 452, 453, 454, and 455, respectively, to indicate the new location (file sub-system 160) of the data, though the content and index can be the same as that received from the file sub-system 120 to the file sub-system 160.

The memory component including a dynamic-programming-language application framework, such as JavaScript, Java or a C/C++ programming language, referenced 162 in FIG. 1, is indicated by a second-level cache 456 in FIG. 4.

Continuing with the multi-tiered arrangement referenced, the storing 306 can include saving the data-content package 412 and the meta-index package 414 to a first-level cache of the memory 152, such as a first-level cache of the file sub-system 160.

As provided, in some embodiments, the operations include one or more real-time adjustment functions, referenced by numeral 307 in FIGS. 3 and 213 in FIG. 2. In the operation at block 213, the processor 114, executing system code, adjusts or manipulates a linkage relationship between the data-content package and the meta-index package in real time at the host system. The host device 150 can perform a similar real-time adjustment, at block 307, in addition to or instead of such adjustment at the portable system 110. The functions of block 307 can be like those described above in connection with block 213.

As provided, operations of the method 300 can be performed in any order, and operations can be combined to a single step, or separated into multiple steps. Regarding the storing operation 306, for instance, the storing can be performed in one or respective single steps corresponding to each package (data and index). The host device 150 can store the data-content package 452 and the meta-index package 454 to the storage device 152, in a single operation, for instance. And the packages 452, 454 can be part of the same packet, stream, or file, or transferred to the host device 150 by the portable system 110 separately.

Flow proceeds to block 308 whereat the processor 154 publishes the media of the received data package 412 for communication to a user, e.g., vehicle passenger, as a video matching the source video file, virtualized source video, or an equivalent consecutive-image-flow data set representing the screen framebuffer display of any application running at the portable system received by the portable system 110 (operation 204).

As mentioned, the host device 150 in some embodiments has stored in its storage device 152 code of a dynamic programming language 164, such as JavaScript, Java or a C/C++ programming language. The language in some implementations includes an application framework for facilitating image-processing functions of the host device 150. The programming language code can define features, such as operation settings, for communications between the portable system 110 and the host device 150, such as parameters of one or more APIs, and/or the manner by which the image files are processed at the host device 150 to display render the resulting video for publishing to the user.

As provided, in embodiments, the processing hardware device 154, executing the dynamic programming language 164 also receives user-input data sent from the portable processor 114 executing the dynamic programming language 125 stored there.

The language can be used in operations of the host device 150, including image-processing—e.g., reading and display rendering, operations.

Publishing video at operation 308 comprises rendering the data of the image components 453_{1-N} according to an order of the meta index components 455_{1-N} of the corresponding meta-index package 454.

In embodiments, then, the operations include:
data being streamed to the portable system 110—e.g., streaming video—is received to the portable system 110, such as from the framebuffer 411;
image components 413_{1-N} corresponding to the streaming video received being written at the portable system to the portable file sub-system 120, yielding data-content packages 412 the image components are written according to respective pointers (write pointers P_{W}, which can also be referred to by P₁) of the meta-index package 414;
index components 415 being written, at the portable system to the portable file sub-system 120, to include pointers to respective data components 413, yielding the meta-index package 414;
the data-content packages and meta-index packages 412, 414 being transferred to the host-device file sub-system 160 at the host device 150, yielding the data-content and index packages 452, 454 consisting of the image components 453 and index components 455, respectively; and
the image components 453 being read consecutively, one at a time, according to respective pointers (read pointers P_{R}, which can also be referred to by P₂) in the corresponding index 454.

These functions can be performed in a round-robin manner. The configuration of the present technology ensures that the write pointer (P_{W}, or P₁) is always one step ahead of the read pointer (P_{R}, or P₂)—i.e., ensures that P₁ always equals P₂−1.

If P₁>P₂, then images read at the host device (by the index 454 there) will not be valid, if P₁=P₂, there would be a read-write conflict, and if P₁<P₂ (e.g., P₁<<P₂), there would be a large latency in the video streaming. To achieve the read-write arrangement described (P₁=P₂−1), conventional systems require relatively expensive, and corresponding software, for fine-timing synchronization between the host device and the portable system. Any frequency offset between clocks of the two apparatus (host device and portable system) would accumulate until P₂−P₁ does not equal to 1. The event-driven configuration of the present technology achieves the desired result in a much-more efficient manner.

As provided, this arrangement—including receiving a meta index of meta index components corresponding in order to image components for sequential display rendering—provides an efficient and effective form of synchronization without requiring expensive clock synchronizing. The processing of each image component 413 can be triggered by reading the corresponding index component 415. Each next index component (e.g., 415₂) is read following processing of a prior image component (e.g., 413₁), and points the processor 154 to read its corresponding image component (e.g., 413₂). The synchronization can be referred to as event-based synchronization, whereby none of the image components will be processed out of order. The event-based synchronization obviates the need for expensive time or clock synchronization components.

The resulting video is transferred, by wire or wirelessly, to an output 172, such as a display or screen 174, such as an infotainment screen of an encompassing system 151 such as an automobile. The transfer is indicated by numeral 309 in FIG. 3.

At block 310, the host device 150 generates, identifies (e.g., retrieves), receives, or otherwise obtains instructions or messages, such as orders or requests for changing of a feature, such as a setting or function, such as from the input device 172 as indicated schematically by reference numeral 311. Regarding instructions for adjusting a feature of the host device 150, the processor 154 executes the instruction. Regarding instructions for adjusting a feature, such as a setting or function, of the portable system 110, the processor 154 sends the instruction or message to the portable system 110, as indicated by path 217.

In one implementation, at least one communication, other than those transmitting data-content packages 412 and corresponding meta-index packages 414, is shared between the portable system 110 and the host device 150.

In various embodiments, the processor 154 sends to the portable system 110 a communication, such as an instruction or message, from the host device 150. These potential transmissions are indicated by reference numeral 217 in FIGS. 2 and 3.

For embodiments allowing bidirectional, or duplex, communications, communications or data (e.g., image/index package) sent by the portable system 110 are transmitted along the mentioned first, or forward, channel of the connection to the host device 150, and communications sent by the processor 154 to the portable system 110 are transmitted along the mentioned second, or back, channel.

Communications 217 from the portable system 110 to the host device 150 can take any of a variety of forms, such as by being configured to indicate a feature, such as a characteristic, function, parameter, or setting, of the host device 150. The communication 217 can further indicate a manner by which to establish a feature, or to alter such feature previously established at the host device 150.

The feature adjusted can include any of the features—e.g., settings, parameters, functions—described herein, including those mentioned above in association with features of the portable system 110.

By way of example, while the feature can take other forms without departing from the scope of the present technology, in one embodiment the feature is selected from a group consisting of a setting affecting a quality of the image components and a playback setting. Example image quality characteristics include a level of zoom, brightness, or contrast. The playback characteristic can be a feature that affects speed or direction by which the video display rendered is being played, or whether played at all. The playback characteristics can include, for instance, fast-forward, rewind, pause, stop, play, or rate of video play.

Generation of communications 217 from the host device 150 to the portable system 110 can be triggered by user input to an input device 172. The input can include touch input to a touch-sensitive screen 174, for example, and/or audio input to a vehicle microphone 176, for instance.

Communications 217 from the host device 150 to the portable system 110 can take any of a variety of forms, such as by being configured to indicate a feature—e.g., characteristic, function, parameter, or setting—of the portable system 110. The communication 217 can further indicate a manner by which to establish a feature at the portable system 110, or to alter such feature previously established at portable system 110.

While a feature at the portable system 110 affected by a communication 217 from the host device 150 can take other forms without departing from the scope of the present technology, the communication 217 is in various embodiments configured to affect a manner by which the portable system 110 performs any of its operations described, such as a manner by which the portable system 110 divides the source video stream into image components 413, or generates the meta-index package 414.

The process 300 can end 313, or any portions thereof can be repeated, such as in connection with a new video or media, or with subsequent portions of the same video used to generate the first image components 413 and index components 415 at the portable system 110.

### III. FIGS. 6 AND 7

FIG. 6 shows a time chart 600 including a timeline 602 indicating an event-based timing by which circular files (e.g., each data-content package 412/corresponding meta-index package 414 pair) are written and read. FIG. 7 shows a corresponding graph 700 indicating an amount by which consecutive circular files are read over time before a next file is written.

The teachings of FIGS. 6 and 7 together show a manner by which transmissions of the circular files 412 and their readings are synchronized on an event basis, instead of using an expensive clock synchronization arrangement.

The chart 600 shows, above the line 602, functions of the portable system 110, as referenced by bracket 604, and functions of the host device 150—e.g., vehicle head unit—below the line 602, as referenced by bracket 606.

In the host-device section 606, the chart 600 shows a plurality of circular-file-read-commencement points 608, 610, 612, 614, whereat the host device 150 commences reading respective circular files. Thus between each commencement point is a corresponding circular-file read, such as the read indicated by bracket 616 between the last two commencement points 612, 614 called out.

In various embodiments, at least one algorithm controlling when circular files are written controls the writings according to reading status of an immediately previous circular file. In one of the embodiments, the algorithm provides by a first, ‘for,’ thread:

Thread 1

```
for each T2 (618 in FIG. 6):
  If the host device 150 sends a data reading request
    (e.g., a USB packet) to the portable system
    110, then U=C₀;
  else (e.g., read does not occur), then U=U-1 (i.e., U is
    decremented by 1).
```

And by a corresponding second, ‘while,’ thread:

Thread 2

```
while true:
  capture frame (e.g., image components); and
  when ¼C₀ < U < ¾C₀, write circular file,
```

where C₀ represents the initial, complete circular file 412, before it is read at the host device 150. When one quarter of the circular file 412 has been read at the host device 150, then the amount of circular file 412 remaining at that point would be 3/4C₀, and so on.

The fractions shown are only sample values. The fractions could have other values greater than 0 and less than 1. In practice, the values could be set otherwise by users, such as engineers. The setting can be made using a calibration process, such as one in which feedback from test or actual operation of the arrangement 100, or a component thereof, is processed for setting one or more of the values.

The first conditional (if) routine of the first thread [Thread 1] can be a part of the host device 150 reading the circular file, wherein the device 150 reads the data, such as from the portable system 110 in the form of a USB mass storage device, for example, sending a packet such as a USB packet to initiate the reading. By receiving the request from the host device 150, the portable system 110 determines that the reading has occurred or is occurring and can thereby determine a reading time for the file.

The graph 700 shows a timeline 702 along the x-axis, and along the y-axis, an amount of unread portion of the circular file (412 in FIGS. 4 and 5), which can be referred to by U. The graph 700 calls out five (5) primary U values:

(1) a lowest value, U=0, at the x-axis;

(2) a top-most value 706 on the y-axis 704, or U=C₀,

(3) a three-quarters value 708, or U=3/4C₀;

(4) a halved value 710, or U=1/2C₀); and

(5) a one-quarter value 712, or U=1/4C₀.

The fractions shown are only sample values. The fractions could have other values greater than 0 and less than 1. In practice, the values could be set otherwise by users, such as engineers. The setting can be made using a calibration process, such as one in which feedback from test or actual operation of the arrangement 100, or a component thereof, is processed for setting one or more of the values.

The line 701 shows the amount of circular file left throughout reads at the host device 150 of adjacent circular files. The full content of each circular file has an initial maximum value, where the line 701 starts in each section, corresponding to respective circular file reads, at the highest U value 706, or C₀. As each circular file is read, the unread, or U, value, decreases over time, as shown for each read by its descending portion of the line 701.

In the example shown, line 701 is not perfectly symmetric (e.g., it dips below the x-axis, once). This is because intervals between consecutive readings (represented by numeral 616 in FIG. 6) may vary over time. This would be due mainly to a non-real-time nature of programmable languages such as JavaScript. This characteristic adds phase offset between the clocks of the portable system 110 and the host device 150. There is also inherent frequency offset in any distributed system. Both slight frequency and phase offsets are tolerated by the present technology, being accounted for, or absorbed, by the algorithm—reference, for instance, operation of the first thread [Thread 1], above.

New circular files are written—e.g., generated at the portable system 110 and sent to the host device 150—according to the threads [Thread 1], [Thread 2] described above in connection with FIG. 6. Accordingly, a new circular file is written when an immediately previous circular file has been about half read 710—in one embodiment the writing of a next circular file occurs when the unread portion (or the read portion) of the circular file is between three quarters 708 and one quarter 712 of the original total circular file (C₀).

In this way, one circular file is sent at a time, and a next circular file is being received at the host device 150 at the time that the host device is completing reading the immediately preceding circular file. And the next circular file can be read, starting with a first image component (e.g., 413₁) of a next circular file 412_{F}, immediately after a final image component (e.g., 413_{N}) of the immediately preceding circular file 412_{F-1} is read.

V. SELECT BENEFITS OF THE PRESENT TECHNOLOGY

Many of the benefits and advantages of the present technology are described above. The present section restates some of those and references some others. The benefits are provided by way of example, and are not exhaustive of the benefits of the present technology.

The technology allows robust and efficient transfer and real-time display of video data in between connected devices without need for expensive time synchronization practices. Synchronization is event-based instead of simply time-based, such as between system and device clocks. The event-based synchronization being accomplished using a multi-tiered file-transfer arrangement. A first tier comprises index features corresponding to a second tier of image data features.

Adaptability to present circumstances and/or preferences allows media transfer tailored to present circumstances and/or preferences, such as characteristics of a present media, an identification of a relevant application running at the host device to publish the resulting video, a category to which the application belongs, and a type of application running at the host device to publish the resulting video, and a characteristic of a vehicle status, such as a characteristics or status indicated by one or more of various vehicle sensor readings.

The systems and algorithms described can be used to transfer high-speed video streams by way of relatively low-transfer-rate connections, such as a USB connection.

The present technology in at least these ways solves prior challenges to transferring and displaying in real time high-throughput media from a source, such as a remote server, to a destination host device, such as an automotive head unit, without need for expensive time synchronization software or hardware, and without requirements for relatively expensive high-end wireless-communications and graphics-processing hardware at the host device.

The portable systems allow streaming of video data at a pre-existing host device, such as an existing automotive on-board computer in a legacy or on-road vehicle—e.g., a vehicle already in the marketplace.

As another benefit, the capabilities can further be provided using a portable system to include mostly, or completely, parts that are readily available and of relatively low cost.

### VI. CONCLUSION

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. An apparatus, for use in rendering media in real-time by way of a distributed arrangement comprising a portable system and a host device, comprising:
a processing hardware unit; and
a non-transitory storage device comprising computer-executable code that, when executed by the processing hardware unit, causes the processing hardware unit to perform operations comprising:
selecting a multi-tier frame-buffering technique, of a plurality of optional multi-tier frame-buffering techniques, to use for processing source media data at the portable system and transferring processed media data from the portable system to the host device; and
initiating transferring, according to the selected frame-buffering technique, the processed media data by the portable system to the host device for processing at the host device for rendering the media.

2. The apparatus of claim 1, wherein the plurality of optional multi-tier frame-media data represents a display screen framebuffer of at least one application operating at the host device for communicating information to a host-device user.

3. The apparatus of claim 1, wherein the plurality of optional multi-tier frame-buffering techniques consists of a circular frame-buffering technique and a single-file frame-buffering technique.

4. The apparatus of claim 3, wherein:
according to the circular frame-buffering technique, the portable system, (a) forms a group of media snippets based on source media, for a content tier, (b) associates a group of index files, for an index tier, to the group of media snippets, each index file being associated with a corresponding one of the media snippets, and (c) sends a multi-tier packet, comprising the group of media snippets and the group of corresponding index files, to the host device; and
according to the single-file frame-buffering technique, the portable system (i) separates source media into media snippets, for a content tier, (ii) associates each of a plurality of index files, for an index tier, with a corresponding one of the media snippets, yielding index file/media snippet pairs, and (iii) sends each index file/media snippet pair to the host device separately.

5. The apparatus of claim 1, wherein selecting the multi-tier frame-buffering technique is performed based on at least one variable selected from a group consisting of:
an identity of an application to be used in rendering the media at the host device;
a type of application to be used in rendering the media at the host device;
an application category to which belongs the application to be used in rendering the media at the host device;
a characteristic of the media being transferred;
an identity of the media being transferred; and
a vehicle-status characteristic.

6. The apparatus of claim 1, wherein the source media comprises a source video file, a virtualized source video, or other consecutive-image-flow data set source.

7. The apparatus of claim 1, wherein the apparatus comprises the portable system, and the processing hardware unit and the non-transitory storage device are parts of the portable system.

8. The apparatus of claim 1, wherein the apparatus comprises the host device, and the processing hardware unit and the non-transitory storage device are parts of the host device.

9. The apparatus of claim 1, wherein initiating transfer of the processed media data comprises initiating transfer of equal-sized image components generated at the portable system based on the source media.

10. A host device, for use in rendering media in real-time by way of a distributed arrangement comprising a portable system and the host device, comprising:
a processing hardware unit; and
a non-transitory storage device comprising computer-executable code that, when executed by the processing hardware unit, causes the processing hardware unit to perform operations comprising:
receiving, from the portable system, source media configured according to one of a plurality of optional multi-tier frame-buffering techniques, media files comprising content components, of a content tier, and index files, of an index tier, each index file corresponding to a respective one of the content components; and
publishing, to a display component in communication with the processing hardware unit, content of the content components sequentially, in accord with an order of the index file, for display rendering the source media.

11. The host device of claim 10, wherein receiving the source media comprises receiving the content components, being equal-sized image components generated at the portable system based on the source media, and receiving the index files, each index file corresponding to a respective one of the equal-sized image components.

12. The host device of claim 10, wherein the plurality of optional multi-tier frame-buffering techniques consists of a circular frame-buffering technique and a single-file frame-buffering technique.

13. The host device of claim 12, wherein:
according to the circular frame-buffering technique, the portable system, (a) forms a group of media snippets based on source media, for a content tier, (b) associates a group of index files, for an index tier, to the group of media snippets, each index file being associated with a corresponding one of the media snippets, and (c) sends a multi-tier packet, comprising the group of media snippets and the group of corresponding index files, to the host device; and
according to the single-file frame-buffering technique, the portable system (i) separates source media into media snippets, for a content tier, (ii) associates each of a plurality of index files, for an index tier, with a corresponding one of the media snippets, yielding index file/media snippet pairs, and (iii) sends each index file/media snippet pair to the host device separately.

14. A portable system, for use in rendering media in real-time by way of a distributed arrangement comprising the portable system and a host device, comprising:
a processing hardware unit; and
a non-transitory storage device comprising computer-executable code that, when executed by the processing hardware unit, causes the processing hardware unit to perform operations comprising:
receiving source media from a media source;
dividing the source media into a plurality of content snippets;
generating a plurality of index components, each index component corresponding to a respective one of the content snippets;
determining a multi-tier frame-buffering technique, of a plurality of optional multi-tier frame-buffering techniques, to use for processing the source media and transferring the media data, as processed, to the host device; and
sending the content snippets and the index components to the host device, according to the determined frame-buffering technique, for processing at the host device for rendering the media.

15. The portable system of claim 14, wherein the plurality of optional multi-tier frame-buffering techniques consists of a circular frame-buffering technique and a single-file frame-buffering technique.

16. The portable system of claim 15, wherein:
according to the circular frame-buffering technique, the portable system, (a) forms a group of media snippets based on source media, for a content tier, (b) associates a group of index files, for an index tier, to the group of media snippets, each index file being associated with a corresponding one of the media snippets, and (c) sends a multi-tier packet, comprising the group of media snippets and the group of corresponding index files, to the host device; and
according to the single-file frame-buffering technique, the portable system (i) separates source media into media snippets, for a content tier, (ii) associates each of a plurality of index files, for an index tier, with a corresponding one of the media snippets, yielding index file/media snippet pairs, and (iii) sends each index file/media snippet pair to the host device separately.

17. The portable system of claim 14, wherein determining the multi-tier frame-buffering technique comprises selecting the multi-tier frame-buffering technique from amongst the plurality of optional multi-tier frame-buffering techniques, based on at least one variable selected from a group consisting of:
an identity of an application to be used in rendering the media at the host device;
a type of application to be used in rendering the media at the host device;
an application category to which belongs the application to be used in rendering the media at the host device;
a characteristic of the media being transferred;
an identity of the media being transferred; and
a vehicle-status characteristic.

18. The portable system of claim 14, wherein the source media comprises a source video file, a virtualized source video, or other consecutive-image-flow data set source.

19. The portable system of claim 14, wherein determining the multi-tier frame-buffering technique comprises receiving an instruction, affecting a portable-system setting affecting a manner by which the selected multi-tier frame-buffering technique is selected amongst the optional multi-tier frame-buffering techniques.

20. The portable system of claim 14 wherein dividing the source media into the plurality of content snippets comprises dividing the source media into a plurality of equal-sized snippets.
